(19) United States
(12) Patent Application Publication
(10) Pub. No.: US 2014/0013947 A1
(43) Pub. Date: Jan. 16, 2014

(54) METHOD AND APPARATUS FOR CONTINUOUS RESIN DEGASSING

(71) Applicant: Xiaoming Liu, Shanghai (CN)

(72) Inventor: Xiaoming Liu, Shanghai (CN)

(73) Assignee: General Electric Company, Schenectady, NY (US)

(21) Appl. No.: 14/005,846

(22) PCT Filed: Apr. 6, 2011
(86) PCT No.: PCT/CN2011/000579

§ 371 Date: Sep. 18, 2013

(51) Int. Cl. B29B 13/00

(52) U.S. Cl. CPC B29B 13/00
USPC 95/248; 96/193; 96/156; 96/174; 95/247

(57) ABSTRACT

An apparatus and method for the treatment of a resin to remove gas from the resin are provided. The apparatus can be operated continuously so that multiple amounts of resin can be consecutively degassed until the overall desired amount of resin has been provided. Thus, batch treatment at one time of the entire desired amount of resin for degassing can be avoided. The gases removed from the resin can be readily captured such that e.g., further treatment can occur.

### FIELD OF THE INVENTION

The present invention relates to degassing a resin in order to remove air and other gases that can be entrapped in the resin.

### BACKGROUND OF THE INVENTION

Wind turbines have received increased attention as an environmentally safe and relatively inexpensive alternative energy source. With this growing interest, considerable efforts have been made to develop wind turbines that are reliable and efficient. Such efforts have included development of improved methods for manufacturing various components of a wind turbine.

Various resins can be used in the manufacture of wind turbine components such as the blades. Generally speaking, the resin can be transferred into a mold at low pressure and low viscosities. The mold may include preforms constructed from e.g., fiber based materials for infusion with the resin in order to provide reinforcement and create a part that is high in strength, low in weight, and aerodynamic. Multiple, detailed components can be combined in a unitary configuration in a single molding process.

The blades of a wind turbine can be quite large in size. For example, blade lengths as great as 60 meters or larger have been produced. In the production of such blades using a resin, a substantial amount of material is required for infusion into the mold during the molding process.

In the process of preparing the resin for use in such a molding process, air and other gases can be entrapped within the resin. The removal of such gases from the resin before infusion into the mold is desirable. If left in the resin, these gases created can create defects in the resulting parts. However, in the case of large parts such as wind turbine blades, the removal of such gases at one time from the entire amount of resin required for the part is time consuming because of the amount of material involved and the length of time required for such removal. In addition, for such batch processing, the amount of resin requires equipment on a scale that can process the large batches at one time. Such larger equipment provides increased complexity and higher manufacturing costs.

The removal of gases from a resin can also present challenges due to the presence of volatiles or other by-products in the removed gases. In general, it is desirable to capture such for further treatment. For example, it may be desirable to further treat the removed gases such that volatiles or other components can be removed before venting to the atmosphere.

Accordingly, a device or method for the treatment of a resin so as to remove gases such as air from the resin prior to transfer into a mold would be useful. The ability to remove gases from relatively large quantities of resin required for large parts would be particularly beneficial. Such a device or method that could be operated in continuous fashion rather than in batch quantities would also be useful. Additional benefits can be derived if such device or method allows for the capture of the gases removed from the resin so that further treatment of the gases may be undertaken.

### BRIEF DESCRIPTION OF THE INVENTION

Aspects and advantages of the invention will be set forth in part in the following description, or may be obvious from the description, or may be learned through practice of the invention.

In one exemplary embodiment of the present invention, an apparatus for treating a resin is provided. The apparatus includes a first chamber having a resin intake for the transfer of resin into the first chamber. The first chamber is also configured for connection with a vacuum source whereby the first chamber may be subjected to a vacuum. A second chamber is provided that is in fluid communication with the first chamber such that resin may be transferred from the first chamber to the second chamber. A third chamber is provided that is in fluid communication with the second chamber such that resin may be transferred from the second chamber to the third chamber. The third chamber is also configured with a resin outtake for the transfer of resin out of the third chamber. A piston is positioned within the second chamber.

The piston is configured for applying a pressure to the resin in the second chamber so as to force the resin into the third chamber.

In another exemplary aspect of the present invention, a method for degassing a resin is provided. The method includes the steps of transferring the resin into a first chamber; subjecting the resin to a vacuum while in the first chamber; transferring the resin into a second chamber; and applying a pressure to the resin while in the second chamber to as to force the resin into a third chamber.

In still another exemplary aspect of the present invention, a method of continuous degassing of a resin is provided. The method includes the steps of supplying the resin in portions; receiving each portion, in a consecutive manner, into a chamber; applying a pressure to each portion, in a consecutive manner, while in the chamber; and, transferring each portion, in a consecutive manner, to a molding process.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates an exemplary embodiment of an apparatus as may be used to remove gas from a resin. FIG. 1 shows the apparatus in a beginning state where no resin has been introduced into the apparatus.

FIG. 2 illustrates the exemplary embodiment of FIG. 1 at a stage where resin has been introduced into a first chamber of the apparatus.

FIG. 3 illustrates the exemplary embodiment of FIG. 1 at a stage where resin is being transferred from the first chamber to a second chamber of the apparatus.

FIG. 4 illustrates the exemplary embodiment of FIG. 1 at stage where resin is being transferred from a second chamber to a third chamber of the apparatus. Also illustrated is the removal of degassed resin from the third chamber.

### DETAILED DESCRIPTION OF THE INVENTION

The present invention provides an apparatus and method for the treatment of resin to remove entrained gases. The removal can be operated continuously so that relatively smaller amounts of resin can be treated in multiple steps as opposed to a single treatment at one time of all the resin needed for a relatively large part. The gases removed from the resin are readily captured such that further treatment may be applied to remove e.g., volatiles or other components.

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

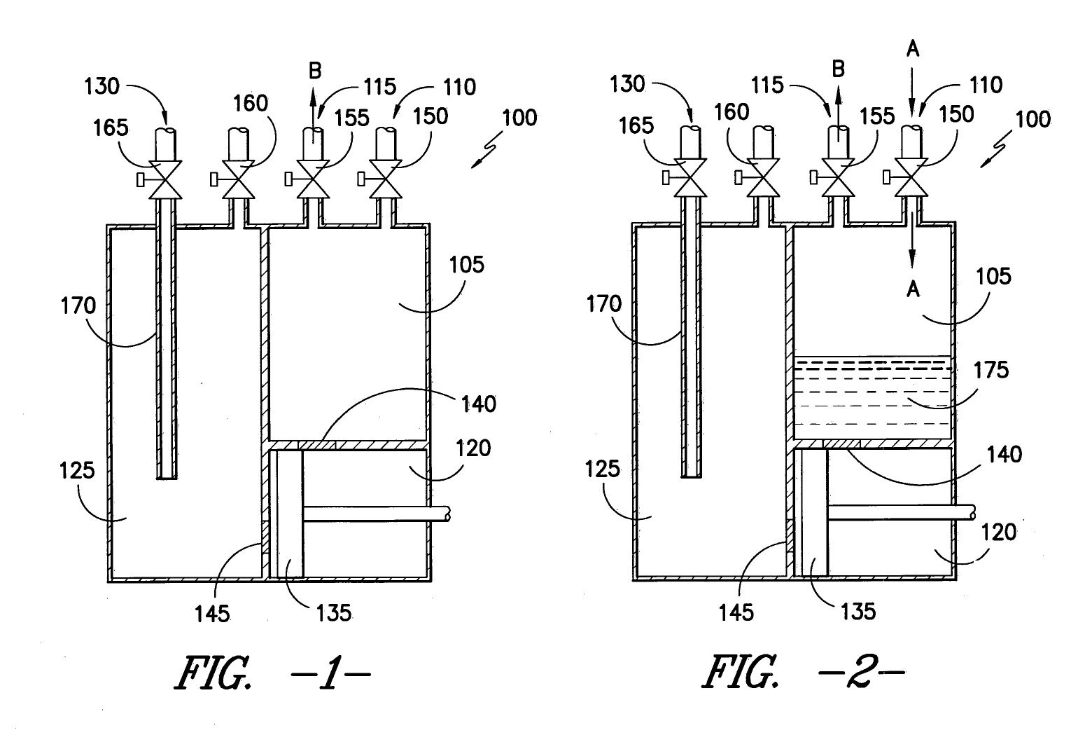

FIGS. 1-4 provide schematic views of an exemplary embodiment of an apparatus 100 for continuously removing gases from a resin 175. Beginning with FIG. 1, for this exemplary embodiment, apparatus 100 includes three chambers: first chamber 105, second chamber 120, and third chamber 125. Apparatus 100 could be constructed, e.g., from a metal vessel having internal walls to create the configuration of chambers 105, 120 and 125 shown in FIG. 1. The present invention is not limited to the relative size and orientation for the chambers as shown in FIG. 1, it being understood that other sizes and configurations may be used according to the teachings disclosed herein.

First chamber 105 includes an intake 110 for the introduction of resin 175 into apparatus 100. Intake 110 may be constructed e.g., as a conduit or pipe connected to apparatus 100 and opening into first chamber 105. Resin intake 110 includes a first valve 150, which may be used to selectively control the flow of resin 175 into first chamber 105 of apparatus 100. Accordingly, resin intake 110 may be connected to a e.g., a resin mixing machine such that shortly after preparation of the resin 175, it can be transferred to apparatus 100 for degassing.

First chamber 105 is also equipped with a vacuum source 115. For example, vacuum source 115 may be conduit that is connected to a vacuum pump. As such, vacuum source 115 can be used to pull a vacuum on first chamber 105 in preparation for degassing a resin 175. Second valve 155 provides for selective control of the pulling of a vacuum on first chamber 105 using vacuum source 115.

In order to remove gas from resin 175 in first chamber 105 as shown in FIG. 2, vacuum source 115 and second valve 155 can be operated according to several different techniques. For example, before introducing resin 175 into first chamber 105 (as shown in FIG. 1), second valve 155 can be opened to draw a vacuum on first chamber 105. Resin 175 can then be introduced into first chamber 105 where the vacuum will cause gases to be released from the resin as it is introduced into first chamber 105. Such gases are withdrawn through valve 155 and towards vacuum source 115. The gases can thereby be collected for further treatment. Additionally, after resin 175 is placed in first chamber 104 as shown in FIG. 2, second valve 155 can be allowed to remain open so that resin 175 remains under a vacuum to thereby continue withdrawing gases entrained in resin 175.

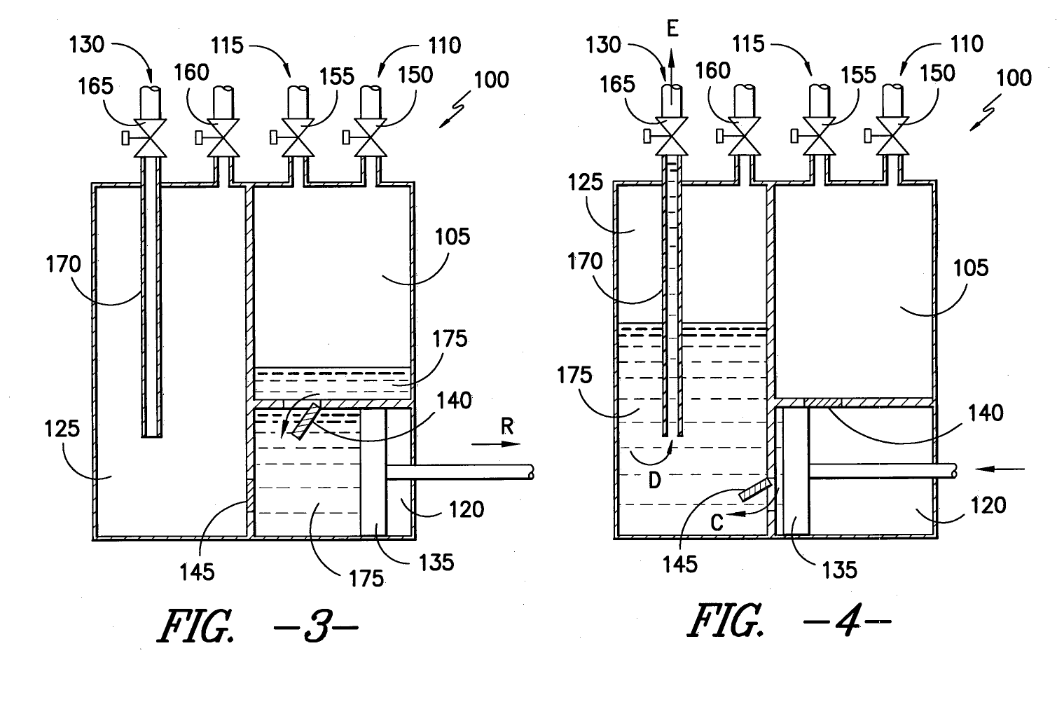

For the exemplary embodiment shown in FIG. 1, second chamber 120 is located below first chamber 105. Although other configurations may be used, this construction allows for gravity assist in the transfer of resin 175 from first chamber 105 to second chamber 120. Second chamber 120 is in fluid communication with first chamber 105 through a first control element 140. More specifically, first control element 140 can be switched between a closed position as shown in FIGS. 1, 2, and 4 and the open position shown in FIG. 3. Accordingly, first control element 140 can be operated to prevent resin 175 from flowing from second chamber 120 back into first chamber 105. By way of example, first control element 140 is shown in FIG. 1 as a door that is movable between open and closed positions. However, first control element 140 could also be constructed from a valve such as a check valve or other constructions that allow for a one-way flow between first chamber 105 and second chamber 120.

Second chamber 120 is also equipped with a piston 135. In FIG. 1, piston 135 is a in a closed position that can be used to block the opening of first control element 140 while a vacuum is being pulled on first chamber 105 and/or resin 175 is introduced into first chamber 105 as shown in FIG. 2. Upon withdrawing piston 135 along a direction R as shown in FIG. 3, first control element 140 is allowed to open to allow resin 175 into second chamber 120. Piston 135 can also be used to draw a vacuum on second chamber 120 as piston 135 is withdrawn along direction R so as to draw resin 175 from first chamber 105.

Conversely, once resin 175 is placed into second chamber 120, piston 135 can be used to apply a pressure that forces resin from second chamber 120 into third chamber 125. More specifically, third chamber 125 is in fluid communication with second chamber 120 through second control element 145. After closing first control element 140, piston 135 is moved inwardly as shown by arrow L in FIG. 4. By opening second control element 145, pressure provided by piston 135 causes resin to transfer from the second chamber 120 into third chamber 125. Second control element 145 is shown as a hinged door. However, other constructions such as e.g., a check valve may also be used.

Third chamber 125 is equipped with a resin outtake 130 for allowing resin to flow from the third chamber 125 (shown by arrow D in FIG. 4) to e.g., a molding process where the resin will be infused into a part such as a blade for a wind turbine. Flow to resin outtake 130 is controlled by fourth valve 165. As shown in FIG. 4, by opening valve 165, resin can move through a conduit 170 and into resin outtake 130 for delivery to an infusion process. To facilitate the movement of resin into conduit 170, third valve 160 can be opened to allow gas into third chamber 125 to provide a vacuum break whereby gas can fill the increased space provided by the removal of resin 175. In addition, a vacuum can be placed onto resin outtake 130 to assist in withdrawing resin from third chamber 125 and/or a gas pressure can be provided through valve 160 to force resin to flow into and through conduit 170.

Accordingly, returning to FIG. 1, resin treatment apparatus 100 can be operated by placing first chamber 105 under a vacuum using vacuum source 115 and an open second valve 155. Preferably, piston 135 is in the closed position shown in FIG. 1, first control element 140 is closed as also shown, and first valve 150 is also closed.

Next, resin 175 is transferred through open first valve 150 and into first chamber 105 as shown by arrow A in FIG. 2. During this time, second valve 155 remains open so as to continue placing first chamber 105 under a vacuum to remove gases entrained with resin 175. As stated previously, these gases can be captured for further treatment as needed to e.g., remove volatiles or other by-products. After a sufficient amount of resin 175 has been placed into first chamber 105, first valve 150 is closed.

After resin 175 has been degassed for a sufficient amount or period of time, second valve 155 is closed. Piston 135 is moved in the direction of arrow R to an open position as shown in FIG. 3 and first control element 140 is allowed to open so that resin 175 can flow from first chamber 105 into second chamber 120. Such flow can be under the operation of gravity and/or the effect of a vacuum created by the movement of piston 135.

Once resin 175 has been transferred into second chamber 120, piston 135 is moved in the direction of arrow L as shown in FIG. 4 so as to place resin 175 under pressure. By opening second control element 145 (as also shown in FIG. 4), such pressure causes the resin to transfer into third chamber 125. Once all resin 175 has been transferred to the third chamber 125, piston 135 is now in the closed position shown in FIG. 4. This is the original starting position of piston 135 that is illustrated in FIG. 1, whereby the cycle can be repeated again.

With resin 175 now in place in third chamber 125, second control element 145 is closed. Resin 175 is now removed from third chamber 125, through conduit 170 and an open valve 165, and on to resin outtake 130 for use in manufacture of a part. As previously described, valve 160 can be opened to provide a vacuum break and/or the addition of pressure into third chamber 125 so as to help force resin 175 through conduit 170.

The exemplary method just described for operating apparatus 100 can be repeated continuously to provide the desired amount of resin 175 for feeding to a molding process. For example, portions of the resin can be provided consecutively to apparatus 100 for treatment of each portion as described to provide a continuous feed of resin to a manufacturing process. In this way, the amount of resin 175 present within apparatus 100 at any one time does not have to equal or exceed the amount that would be used in manufacturing a particular part fed by resin outtake 130. Instead, resin can be mixed and fed to apparatus 100 for degassing on a continuous basis until enough resin 175 has been created and degassed for the manufacture of the part.

It should also be noted that during operation, apparatus 100 does not have to start each cycle empty as shown in FIG. 1. Instead, by way of example, as degassed resin 175 is delivered into third chamber 125, resin 175 in need of degassing can simultaneously be delivered to first chamber 105 and subjected to a vacuum. Once piston 135 has pushed all degassed resin 175 into third chamber 125, additional resin can be withdrawn from first chamber 105 by movement of piston 135 in the direction of arrow R as shown in FIG. 3. This movement can take place while resin 175 in third chamber 125 is being ejected through conduit 170. In this manner, apparatus 100 can be operated continuously until the desired amount of degassed resin 175 has been provided. Using the teachings disclosed herein, other techniques for the continuous operation of apparatus 100 may also be devised.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

COMPONENT LIST

| Reference Character | Component |
|---|---|
| 100 | resin treatment apparatus |
| 105 | first chamber |
| 110 | resin intake |
| 115 | vacuum source |
| 120 | second chamber |
| 125 | third chamber |
| 130 | resin outtake |
| 135 | piston |
| 140 | first control element |
| 145 | second control element |
| 150 | first valve |
| 155 | second valve |
| 160 | third valve |
| 165 | fourth valve |
| 170 | conduit |
| 175 | resin |

What is claimed is:

1. An apparatus for treating a resin, comprising:
a first chamber having a resin intake for the transfer of resin into said first chamber, said first chamber configured for connection with a vacuum source whereby said first chamber may be subjected to a vacuum;
a second chamber in fluid communication with said first chamber such that resin may be transferred from said first chamber to said second chamber;
a third chamber in fluid communication with said second chamber such that resin may be transferred from said second chamber to said third chamber, said third chamber configured with a resin outtake for the transfer of resin out of said third chamber; and,
a piston positioned within said second chamber, said piston configured for applying a pressure to resin in said second chamber so as to force the resin into said third chamber.

2. An apparatus for treating a resin as in claim 1, further comprising a first control element configured for selectively controlling the flow of resin between said first chamber and said second chamber.

3. An apparatus for treating a resin as in claim 2, further comprising a second control element configured for selectively controlling the flow of resin between said second chamber and said third chamber.

4. An apparatus for treating a resin as in claim 1, further comprising a first valve positioned along the resin intake of said first chamber and configured for selectively controlling the flow of resin into said first chamber.

5. An apparatus for treating a resin as in claim 1, further comprising a second valve in fluid communication with said first chamber and configured to selectively control the connection with the vacuum source used to subject said first chamber to a vacuum.

6. An apparatus for treating a resin as in claim 1, further comprising a third valve in fluid communication with said third chamber and configured for selectively releasing fluid from said third chamber.

7. An apparatus for treating a resin as in claim 1, further comprising a fourth valve in fluid communication with said third chamber and configured for selectively allowing resin to transfer from said third chamber.

8. An apparatus for treating a resin as in claim 7, further comprising a conduit extending into said third chamber, said conduit in fluid communication with said fourth valve and configured to feed resin to said fourth valve from said third chamber.

9. A method for degassing a resin, comprising the steps of:
transferring the resin into a first chamber;
subjecting the resin to a vacuum while in the first chamber;
transferring the resin into a second chamber; and,
applying a pressure to the resin while in the second chamber to as to force the resin into a third chamber.

10. A method for degassing a resin as in claim 9, further comprising the step of blocking the flow of resin from the second chamber into the first chamber during said step of applying.

11. A method for degassing a resin as in claim 10, further comprising the step of blocking the flow of resin from the first chamber into the second chamber during said steps of transferring and subjecting.

12. A method for degassing a resin as in claim 9, wherein said step of transferring comprises creating a vacuum to the second chamber so as to pull resin from the first chamber into the second chamber.

13. A method for degassing a resin as in claim 12, wherein said step of creating a vacuum comprises moving a piston so as draw resin into the second chamber.

14. A method for degassing a resin as in claim 9, wherein said step of applying a pressure comprises moving a piston so as force the resin from the second chamber to the third chamber.

15. A method for degassing a resin as in claim 9, further comprising the step of releasing fluid from the third chamber during or after said step of applying.

16. A method for degassing a resin as in claim 9, further comprising the step of transferring resin out of the third chamber.

17. A method for degassing a resin as in claim 9, wherein said transferring step comprises applying a pressure to the resin.

18. A method for degassing a resin as in claim 9, further comprising the step of repeating said steps of transferring the resin into a first chamber, subjecting the resin to a vacuum, transferring the resin into a second chamber, and applying a pressure to the resin, so as provide a continuous feed of resin from the third chamber to a molding process.

19. A method of continuous degassing of a resin, comprising the steps of:
supplying the resin in portions;
receiving each portion, in a consecutive manner, into a chamber;
applying a pressure to each portion, in a consecutive manner, while in the chamber; and,
transferring each portion, in a consecutive manner, to a molding process.
